(19) United States
(12) Patent Application Publication
(10) Pub. No.: US 2008/0109862 A1
(43) Pub. Date: May 8, 2008

(54) METHOD AND APPARATUS FOR PREDICTING FAILURES IN SET-TOP BOXES AND OTHER DEVICES TO ENABLE PREVENTATIVE STEPS TO BE TAKEN TO PREVENT SERVICE DISRUPTION

(75) Inventors: Arthur P. Jost, Mount Laurel, NJ (US); John E. Burke, Ambler, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/557,144

(22) Filed: Nov. 7, 2006

(51) Int. Cl. H04N 7/173

(52) U.S. Cl. 725/107

(57) ABSTRACT

A method and apparatus are provided for predicting failures of hard disk drive systems in set-top boxes (STBs) to enable preventative steps to be taken to prevent a disruption of services to the subscriber. One or more conditions in a STB, such as, for example, ambient temperature, available disk drive storage space, etc., are measured and a failure prediction algorithm is performed to predict the likelihood that a failure will occur. The prediction may be reported to a STB servicing entity to enable a service call to be arranged for the subscriber before services are disrupted due to a failure of the hard disk drive system.

### TECHNICAL FIELD OF THE INVENTION

The invention relates to predicting failures in devices such as set-top boxes, for example. More particularly, the invention relates to using measurements of conditions in set-top boxes (STBs), such as ambient temperature, for example, to predict hard drive failures so that preventative measures can be taken to prevent a disruption of services.

### BACKGROUND OF THE INVENTION

The failure rate of a computer hard drive disk system is related to the temperatures to which the hard drive system is exposed and the length of time of exposure. In general, hard disk drive systems that are exposed to higher temperatures over a given period of time are more likely to fail than hard disk drive systems that are exposed to lower temperatures over the same period of time.

Cable, satellite and Internet Protocol Television (IPTV)/Digital Subscriber Line (DSL) set-top boxes (STBs) commonly contain hard disk drive systems used as storage for personal video recorder (PVR) functions. When a STB hard disk drive system fails, the STB ceases to function properly, resulting in loss of any stored programs, and potentially resulting in a disruption in the delivery of programming and other cable services to the subscriber's premises. In response, a technician is typically dispatched to the subscriber's premises to replace the STB having the failed hard disk drive system with a working STB. Once the STB having the failed hard disk drive system has been replaced with a working STB, services may be restored, but recorded programs are generally not recoverable.

It would be desirable to provide a way to predict when a STB hard disk drive system is likely to fail so that preventative action can be taken prior to failure. By taking preventative action prior to a STB hard disk drive failure occurring, service disruption and dispatch scheduling difficulties can be avoided.

### BRIEF DESCRIPTION OF THE DRAWINGS

FIG. 1 illustrates a network diagram demonstrating the reporting of the temperature inside of the STB chassis to a processor at the headend that monitors one or more conditions in the STB chassis and determines whether the hard disk drive system is likely to fail in the near future.

FIG. 2 illustrates a block diagram of the apparatus of the invention in accordance with one illustrative embodiment for determining whether a STB hard disk drive system failure is likely to occur in the near future.

FIG. 3 illustrates a block diagram of the apparatus of the invention in accordance with another illustrative embodiment for determining whether a STB hard disk drive system failure is likely to occur in the near future.

FIG. 4 illustrates a flowchart that demonstrates a first illustrative method performed by the STB for determining whether a STB hard disk drive system failure is likely to occur.

FIG. 5 illustrates a flowchart that demonstrates a first illustrative method performed by the headend for determining whether a STB hard disk drive system failure is likely to occur.

FIG. 6 illustrates a flowchart that demonstrates a second illustrative method performed by the STB for determining whether a STB hard disk drive system failure is likely to occur.

FIG. 7 illustrates a flowchart that demonstrates a second illustrative method performed by the headend for determining whether a STB hard disk drive system failure is likely to occur.

### DETAILED DESCRIPTION OF ILLUSTRATIVE EMBODIMENTS

In accordance with the invention, condition data obtained from measuring one or more conditions (e.g., temperature, available memory space, etc.) inside and/or around the STB is used to determine the likelihood that a STB hard disk drive system failure will occur. Based on the determination, one or more preventative actions may be taken to avoid a service disruption. For example, if increased temperatures are detected early enough (e.g., before the probability of failure has been significantly increased), it may be desirable to dispatch a technician to relocate the STB to a cooler location in the subscriber's premises, provide better air circulation around the STB, or take some other action to reduce the STB internal temperature.

Techniques for predicting hard disk drive failures currently exist, including Weibull modeling and a technique known as the self monitoring and reporting technique (S.M.A.R.T.). The S.M.A.R.T. technique has been adopted by the personal computer (PC) disk drive industry for use in predicting disk drive failures in PCs. One of these existing techniques, or a modification of one or more of these existing techniques, could be used with invention to predict disk drive failures in STBs. Alternatively, an entirely new algorithm could be created to predict disk drive failures in STBs. Through the use of one of these known algorithms or some other suitable algorithm, the invention enables failure data to continuously be collected in the headend server from one or more STBs, and then use this data to continuously refine the failure prediction algorithm being used to more accurately predict STB disk drive failures.

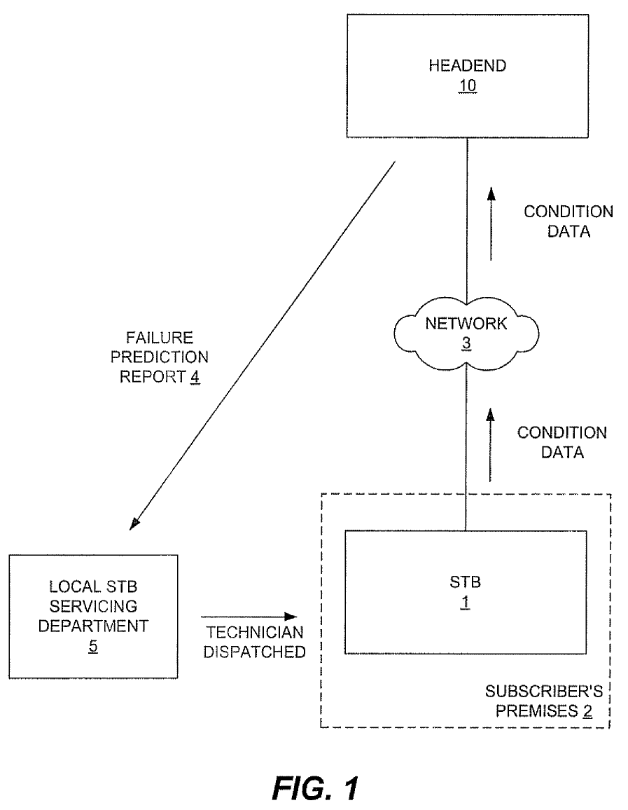

FIG. 1 is a diagram illustrating communication between a STB 1 located at a subscriber's premises 2 and a headend 10 over a network 3, which is typically a community access television (CATV) network. In the downstream direction, the headend 10 transmits video, audio and data over the network 3 to the STB 1. In the upstream direction, the STB 1 transmits data (e.g., impulse-pay-per-view data) and commands (e.g., play, pause, video-on-demand commands, etc.) via a reverse channel to the headend 10. Various protocols are typically used for transmitting data and commands over the network 3 such as, for example, the Data Over Cable Service Interface Specification (DOCSIS) protocol and the Aloha protocol.

Many STBs currently available today include a temperature sensor that is used for on-screen diagnostic display. In accordance with the invention, the STB 1 includes such a temperature sensor (not shown). In accordance with a first illustrative embodiment of the invention, the STB 1 forwards condition data associated with conditions sensed by the condition sensor to the headend 10. A processor (not shown) at the headend 10 processes the condition data in accordance with a failure prediction algorithm to determine the likelihood that the hard disk drive system (not shown) of the STB 1 will fail in the near future. The headend 10 generates a failure prediction report 4 based on the results of the failure prediction algorithm and forwards the report 4 to a local STB servicing department 5. If the report 4 indicates that a hard disk drive system failure is imminent, the local STB servicing department 5 dispatches a technician to the subscriber's premises 2 to replace the STB 1 with a working STB.

Although it may be possible to repair or replace the disk drive system that is predicted to fail soon rather than replace the STB, these tasks typically are not performed at the subscriber's premises. Therefore, the typical course of action will be to replace the STB having the failed hard disk drive system with a different STB. However, it should be noted that this course of action is not a requirement of the invention. The invention also covers cases in which a failure prediction report results in a technician being dispatched to repair or replace the disk drive system of the STB. The technician may perform other tasks altogether, such as, for example, moving the STB to a location with a cooler ambient temperature.

The term “temperature data”, as that term is used herein, is intended to mean any data that provides an indication of temperature, including one or more actual measured temperature values and/or a processing result obtained by processing one or more actual measured temperature values. For example, the term “temperature data” may mean an average of the temperatures measured over a time period, a peak temperature measured during a time period, any other variation of temperature indication, a calculated value relative to the temperature profile, such as an integral over a time period, and/or any combination of these temperature calculations or indications.

It should be noted that hard drive disk system parameters other than temperature (e.g., humidity and dust) may be monitored and acted upon for various reasons. For example, the amount of available storage space on the disk may be monitored and reported. When the disk is nearly full, the service provider or operator may offer to sell or rent additional network storage space to the subscriber on one or more network disk drive systems external to the STB. Information relating to such other parameters may be used instead of or in conjunction with temperature data to determine the likelihood that the hard disk drive system will fail. The term “condition data” is used herein to denote data measured by a condition sensor, including, but not limited to, temperature data.

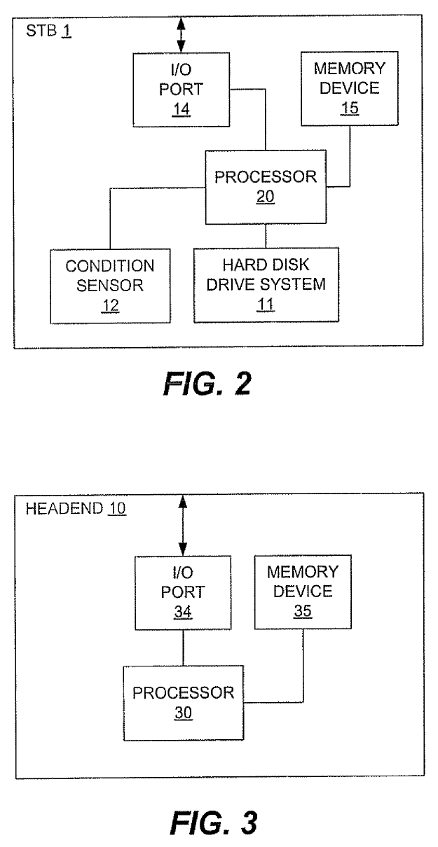

FIG. 2 illustrates a block diagram of the STB 1 of the invention in accordance with a first illustrative embodiment. The STB 1 includes a hard disk drive system 11, a condition sensor 12, a processor 20, which may be the STB host processor or some other processor, and an input/output (I/O) communications port 14. The STB 1 typically also includes a memory device 15 for storing software programs executed by the processor 20 and data.

As described above with reference to FIG. 1, in accordance with the first embodiment, the processor 20 is configured to execute a monitoring and reporting algorithm that monitors the conditions (e.g., temperature, available storage space, etc.) as measured by the sensor 12 over time and reports the data to the headend 10. A processor at the headend then processes the data and generates a failure prediction report that is then sent to the local STB servicing department. The processor 20 is typically a microprocessor programmed with software to perform the tasks associated with reporting the data. However, these tasks may be performed solely in hardware or in a combination of hardware and software. The term “processor”, as that term is used herein, is intended to denote any type of computational device including, for example, a microprocessor, a microcontroller, an application specific integrated circuit (ASIC), a system-on-a-chip (SOC), a programmable gate array, a programmable logic array, etc.

The reporting of the condition data is typically performed periodically (e.g., once a day) although the invention is not limited with respect to how often the condition data is reported or whether it is reported periodically, sporadically, when available bandwidth allows, when the temperature exceeds a predetermined threshold level for longer than a particular time period, etc. In addition, the reporting interval or logic used to determine the reporting interval may be configured or changed from the headend when desired.

FIG. 3 illustrates a block diagram of an illustrative embodiment of a portion of the headend 10 shown in FIG. 1 that receives the condition data sent by the STB 1, processes the data to produce a hard disk drive system failure prediction, and reports the failure prediction results to the local STB servicing department. The portion of the headend 10 that performs these tasks includes a processor 30 and an I/O port 34. The I/O port receives the condition data sent by the STB and forwards it to the processor 30. The processor 30 processes the data in accordance with a failure prediction algorithm and generates a failure prediction report, which is forwarded to the I/O port 34. The I/O port 34 then transmits the failure prediction report to the local STB servicing department. The headend 10 typically also includes a memory device 35 for storing software programs executed by the processor 30 and data.

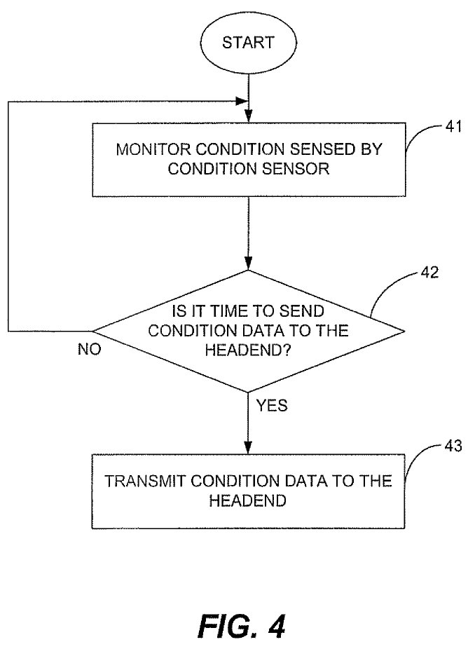

FIG. 4 illustrates a flowchart that demonstrates the method of the invention performed by the STB in accordance with the first illustrative embodiment. A processor of the STB monitors electrical signals produced by the condition sensor relating to the sensed condition, as indicated by block 41. The monitoring process may involve processing of the electrical signals by the processor of the STB in accordance with some algorithm. Alternatively, the processor may simply forward the electrical signals to the headend via the I/O port of the STB. In either case, the sensed condition data is then forwarded to the headend, as indicated by block 43. As stated above, the processor may make some determination as to when (e.g., periodically, when temperature exceeds a particular threshold level, when a certain amount of storage space has been consumed, etc.) to send condition data to the headend 10, as indicated by block 42.

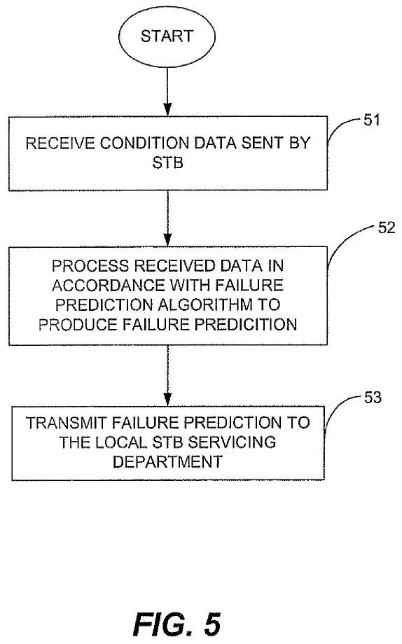

FIG. 5 illustrates a flowchart that demonstrates the method of the invention performed by the headend in accordance with the first illustrative embodiment. The headend receives the condition data sent by the STB, as indicated by block 51. The data is then processed in the manner described above to produce a failure prediction, as indicated by block 52. The failure prediction is then reported to the local STB servicing department, as indicated by block 53.

In accordance with a second illustrative embodiment of the invention, the processor 20 of the STB 1 does not report condition data to the headend 10, but instead processes the condition data obtained from the condition sensor 12 in accordance with a failure prediction algorithm to produce a failure prediction, which is then reported to the headend 10. The headend 10 then sends a failure prediction report to the local STB servicing department.

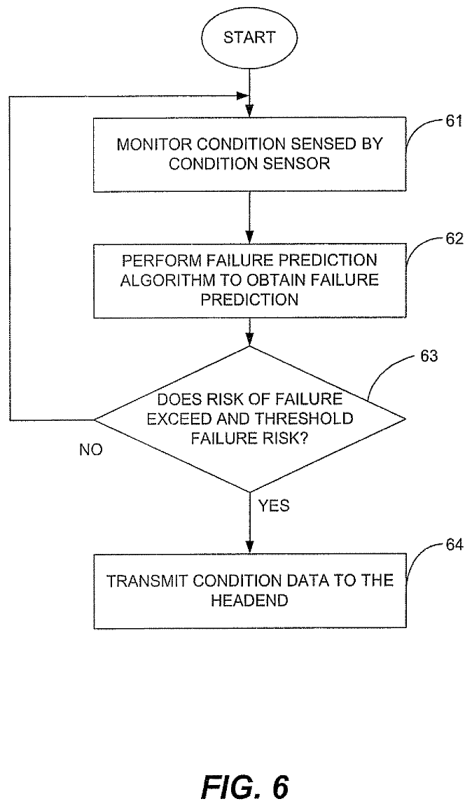

FIG. 6 illustrates a flowchart that demonstrates the method of the invention performed by the STB in accordance with the second illustrative embodiment. A processor of the STB receives monitors the electrical signals produced by the condition sensor relating to the sensed condition of the STB, as indicated by block 61. The electrical signals are digitized by an analog-to-digital converter (not shown), which may be part of the temperature sensor or external to it. The processor processes the signals in accordance with a failure prediction algorithm to obtain a failure prediction, as indicated by block 62. A determination may then be made as to whether the failure risk is greater than a threshold failure risk level, as indicated by block 63. If so, the failure prediction is forwarded to the headend, as indicated by block 64. If not, the processor continues to monitor the condition and calculate the corresponding failure predictions. The algorithm being run in the STP and/or the threshold values can be configured or changed from the headend when desired.

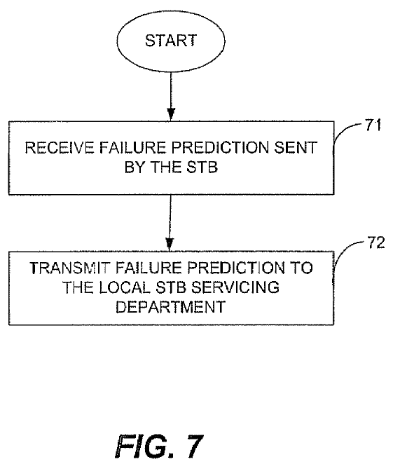

FIG. 7 illustrates a flowchart that demonstrates the method of the invention performed by the headend in accordance with the second illustrative embodiment. In accordance with the second illustrative embodiment, the processor 30 at the headend 10 performs a failure prediction receiving and reporting algorithm. The headend receives the failure prediction sent by the STB, as indicated by block 71. The failure prediction is then reported to the local STB servicing department, as indicated by block 72.

It should be noted that while the invention has been described with reference to STBs, the invention may also be used to predict failures in other types of devices, such as personal video recorders (PVRs), for example. This invention is may be advantageously used to predict hard drive failures in various types of devices to enable preventative steps to be taken to prevent a disruption in services.

Although the algorithms described above are typically performed in software being executed by a processor of some type, the algorithms may be performed solely in hardware or in a combination of hardware and software. As stated above, the software programs are typically stored in the memory devices 15 and 35 shown in FIGS. 2 and 3, respectively. The memory devices 15 and 35 may be physically separate from the processor 20 and 30, respectively, or integrated with them in respective integrated circuits (ICs).

The memory devices 15 and 35 may be any type of computer-readable medium such as, for example, random access memory (RAM), dynamic RAM (DRAM), flash memory, read only memory (ROM) compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats, as well as optical signals transmitted over an optical transmission medium. For example, the signals that are communicated from the STB to the headend and/or from the headend to the local STB servicing department may be transmitted as electrical signals over wires (e.g., coaxial cable), wireless transmitted over air, and/or as optical signals transmitted over optical fibers.

It should be noted that the invention has been described with reference to particular examples and that the invention is not limited to the examples described herein. Those skilled in the art will understand that modifications may be made to the examples described above and that all such modifications are within the scope of the invention.

What is claimed is:

1. An apparatus for predicting a failure of a hard disk drive system of a set-top box (STBs), the system comprising:
an input/output (I/O) port of the STB for sending and receiving information to and from a headend via a network; and
a processor of the STB, the processor being configured to execute a condition monitoring and reporting algorithm to monitor at least one condition within the STB over time as measured by a condition sensor and to cause condition data associated with the measurements to be sent via the I/O port to a headend in communication with the STB.

2. The apparatus of claim 1, wherein the condition data is sent periodically by the STB to the headend, the processor performing an algorithm that determines when a predetermined period of time has lapsed since condition data was last sent by the STB to the headend, wherein if the processor determines that the predetermined period of time has lapsed, the processor causes condition data to be sent via the I/O port to the headend.

3. The apparatus of claim 1, wherein said at least one condition is temperature inside of the STB, an amount of storage space that is available on the hard disk drive system, or a level of humidity in the STB, and wherein the condition data includes one or more of temperature data, available storage space data, and humidity level data.

4. The apparatus of claim 1, wherein the processor only sends condition data to the headend if the processor determines that the data indicates that a failure is likely to occur in the near future.

5. An apparatus for predicting a failure of a hard disk drive system of a set-top box (STBs), the apparatus being located at a headend that is in communication with the STB, the apparatus comprising:
an input/output (I/O) port of the headend for receiving condition data from a STB via a network, the condition data relating to at least one measured condition in the STB; and
a processor of the headend, the processor being configured to execute a failure prediction algorithm that processes the condition data received from the STB to produce a failure prediction for the hard disk drive system.

6. The apparatus of claim 5, wherein the processor of the headend reports the failure prediction to an entity responsible for arranging servicing the STB.

7. The apparatus of claim 1, wherein the processor of the STB is also configured to execute a failure prediction algorithm that processes the condition data and produces a hard disk drive system failure prediction based on one or more of the monitored condition.

8. The apparatus of claim 7, wherein the failure prediction is sent by the apparatus from the STB to the headend via the I/O port of the STB.

9. The apparatus of claim 7, wherein the processor only sends the failure prediction to the headend if the processor determines that said one or more monitored conditions indicate that a failure is likely to occur in the hard disk drive system in the near future.

10. A method for predicting failures in hard disk drive systems of set-top boxes (STBs), the method comprising:
monitoring at least one condition within an STB over time as measured by a condition sensor; and
sending condition data relating to the monitored condition or conditions from the STB to the headend.

11. The method of claim 10, further comprising:
prior to sending the condition data to the headend, determining if a predetermined period of time has lapsed since a last time condition data was sent from the STB to the headend.

12. The method of claim 11, further comprising:
prior to sending the condition data to the headend, determining whether the condition data indicates a likelihood that the hard disk drive system will fail in the near future.

13. The method of claim 10, further comprising:
processing the condition data in accordance with a failure prediction algorithm to produce a failure prediction, the failure prediction predicting a likelihood that the hard disk drive system will fail.

14. The method of claim 12, further comprising:
sending the failure prediction from the STB to the headend.

15. The method of claim 14, further comprising:
prior to sending the failure prediction to the headend, determining whether the failure prediction indicates a relatively high risk that the hard disk drive system will fail in the near future, wherein the failure prediction is only sent to the headend from the STB if it is determined that the failure prediction indicates a relatively high risk that the hard disk drive system will fail in the near future.

16. The method of claim 14, further comprising:
receiving a failure prediction in the headend sent from an STB, the failure prediction predicting a likelihood that the hard disk drive system will fail, the failure prediction being produced in the STB by an algorithm that processes the condition data corresponding to the measurements taken in the STB over time as measured by a condition sensor; and
sending the failure prediction to an entity responsible for arranging servicing of the STB.

17. A computer program for predicting failures in hard disk drive systems of set-top boxes (STBs), the program comprising instructions that are stored on a computer-readable medium, the program comprising:
instructions for processing condition data in accordance with a failure prediction algorithm to produce a failure prediction, the condition data being data obtained by measuring one or more conditions in a STB, the failure prediction predicting a likelihood that the hard disk drive system of the STB will fail.

18. The computer program of claim 17, further comprising:
instructions for monitoring at least one condition within the STB over time as measured by a condition sensor to collect the condition data, wherein the instructions for processing condition data in accordance with a failure prediction algorithm to produce a failure prediction are intended to be executed by a processor of the STB.

19. The computer program of claim 17, further comprising:
instructions for sending the condition data relating to the monitored condition or conditions from the STB to the headend, wherein a device at the headend executes the instructions for processing condition data in accordance with a failure prediction algorithm to produce a failure prediction.
